(19) United States
(12) Patent Application Publication
(10) Pub. No.: US 2026/0028270 A1
(43) Pub. Date: Jan. 29, 2026

(54) METALLIZING SYSTEM AND METHOD FOR METALLIZING A WORKPIECE

(71) Applicant: Owens-Brockway Glass Container Inc., Perrysburg, OH (US)

(72) Inventors: Victor Reveron, Perrysburg, OH (US); Joshua Conley, Perrysburg, OH (US); Matthew Murphy, Perrysburg, OH (US); William Bosken, Monclova, OH (US); Ronald Rook, Bloomdale, OH (US)

(21) Appl. No.: 19/278,771

(22) Filed: Jul. 23, 2025

Related U.S. Application Data
(60) Provisional application No. 63/675,732, filed on Jul. 25, 2024.

(51) Int. Cl. C03C 17/00; C03C 17/10

(52) U.S. Cl. CPC C03C 17/005; C03C 17/10; C03C 2217/25; C03C 2218/13

(57) ABSTRACT

A metallizing system is disclosed that includes a metallizing worktable configured to receive and rotate a worn workpiece, and a metallizing applicator movable towards and away from the metallizing worktable and including a flame spray torch configured to deposit a metallized layer of metal onto the worn workpiece as it rotates relative to the flame spray torch. A robot is configured to acquire and release the worn workpiece and to acquire and release the metallizing applicator, and to move the worn workpiece and the metallizing applicator. A related method of metallizing the worn workpiece to produce the metallized workpiece is also disclosed.

### TECHNICAL FIELD

This patent application discloses innovations related to processes and equipment for metallizing workpieces and, more particularly, to processes and equipment for metallizing workpieces including, for example, mold components used to manufacture glass containers.

### BACKGROUND

Manufacturing of a glass container typically involves receiving a charge of molten glass into a blank mold, forming the molten glass into a parison in the blank mold, transferring the parison from the blank mold to a blow mold, and forming the parison into the finished glass container in the blow mold. The molds include various mold components including, for example, mold bodies, neck rings, neck ring guide plates, guide rings, plungers, baffles, and bottom plates, which are often composed of cast iron or another material that is resistant to thermal fatigue. Despite being constructed from thermal fatigue resistant materials, the mold components tend to wear out over time from repeated contact with the molten glass and/or repeated abrasive contact with other machine components. Instead of being discarded, the mold components may be reconditioned to extend their operational lifetime and mitigate capital expenditures for tooling. The mold components may be reconditioned by metallizing the worn surfaces of the components, which involves depositing a fresh coating of metal over the worn surfaces, and machining the fresh metal to the correct size and/or surface contour for the components. Currently, worn mold components are metallized manually. Manual metallization involves individuals manipulating a worn mold component by hand while spraying metal onto the worn mold components, typically at one or more workbenches equipped with handheld oxy-acetylene torches, with varying degrees of precision. The manual nature of this process renders it susceptible to inconsistent quality between metallized components.

### SUMMARY

In accordance with one aspect of the present disclosure, a metallizing system includes a metallizing worktable configured to receive and rotate a worn workpiece, a metallizing applicator movable towards and away from the metallizing worktable and including a flame spray torch configured to deposit a metallized layer of metal onto the worn workpiece as it rotates relative to the flame spray torch, and a robot configured to acquire and release the worn workpiece and the metallizing applicator and configured to move the worn workpiece and the metallizing applicator.

In accordance with another aspect of the present disclosure, a metallizing system for metallizing worn workpieces into metallized workpieces includes a load/unload station, a pallet at the load/unload station and including a plurality of workpiece holders, each configured to hold a worn workpiece, and a metallizing worktable having a spindle that is rotatable about a rotation axis and includes a chuck. Also, a metallizing applicator is carried by a cradle on the metallizing worktable and is movable towards and away from the spindle and includes a flame spray torch configured to emit a flame and receive powdered metal material into the flame to create a thermal metallic spray. Further, a robot including a common gripper is configured to acquire a worn workpiece from the pallet, transfer it to the metallizing worktable, and release it to the chuck of the spindle, and is also configured to acquire the metallizing applicator from the cradle, articulate the metallizing applicator into position to metallize the worn workpiece into a metallized workpiece, return and release the metallizing applicator to the cradle, acquire the metallized workpiece from the chuck of the spindle, transfer the metallized workpiece to the pallet, and release the metallized workpiece onto the pallet.

In accordance with an additional aspect of the present disclosure, a method of metallizing a worn workpiece to produce a metallized workpiece includes the following steps. A worn workpiece is delivered to a spindle carried on a metallizing worktable and having a chuck in which the worn workpiece received. A metallizing applicator, including a flame spray torch that emits a flame, is advanced towards the metallizing worktable and the worn workpiece. The spindle is rotated to rotate the worn workpiece relative to the flame spray torch such that the worn workpiece rotates through the flame to heat the worn workpiece. The metallizing applicator is articulated with respect to the spindle. A metallized layer of metal is deposited onto the worn workpiece to produce a metallized workpiece by introducing a powdered metal material into the flame of the flame spray torch to create a thermal metallic spray while continuing to rotate the spindle such that the worn workpiece is rotated relative to the flame spray torch and through the thermal metallic spray. The metallizing applicator is retracted away from the metallized workpiece and the metallizing worktable.

### BRIEF DESCRIPTION OF THE DRAWINGS

FIG. 1 is an isometric schematic view of an automatic metallizing system in accordance with an illustrative embodiment of the present disclosure.

FIG. 2 is a plan view of the metallizing system of FIG. 1.

FIG. 3 is a right-side view of the metallizing system of FIG. 1.

FIG. 4 is a front-end view of the metallizing system of FIG. 1.

FIG. 5 is an isometric view of a pallet plate carrying a plurality of workpieces, more specifically, different guide rings.

FIG. 6 is an isometric view of another pallet plate carrying a plurality of other workpieces, more specifically, different baffles.

FIG. 7 is an isometric view of an additional pallet plate carrying a plurality of additional workpieces, more specifically, different plungers.

FIG. 8 is an isometric view of a further pallet plate carrying a plurality of further workpieces, more specifically, different baffles and plungers.

FIG. 9 is an enlarged, fragmentary, isometric, schematic view of a portion of the metallizing system of FIG. 1, illustrating a metallizing workstation including a metallizing worktable and a spindle and a metallizing applicator.

FIG. 9A is a further enlarged, fragmentary, isometric view of a portion of the metallizing applicator of FIG. 9.

FIG. 10 is fragmentary isometric view of a robot end-effector gripping a workpiece, more specifically, a guide ring.

FIG. 11 is fragmentary isometric view of a robot end-effector gripping another workpiece, more specifically, a baffle.

FIG. 12 is fragmentary isometric view of a robot end-effector gripping a further workpiece, more specifically, a plunger.

FIG. 13 is an enlarged, fragmentary, isometric, schematic view of a portion of the metallizing system of FIG. 1, illustrating a robot loading a worn workpiece onto the metallizing workstation.

FIG. 14 is an enlarged, fragmentary, isometric, schematic view of a portion of the metallizing system of FIG. 1, illustrating the robot acquiring a metallizing applicator from a cradle.

FIG. 15 is an enlarged, fragmentary, isometric, schematic view of a portion of the metallizing system of FIG. 1, illustrating the metallizing applicator carried by the robot and advanced to an upper position at the metallizing workstation and a front end of the metallizing applicator emitting a flame to an upper portion of the worn workpiece.

FIG. 16 is an enlarged, fragmentary, isometric, schematic view of a portion of the metallizing system of FIG. 1, illustrating the metallizing applicator carried by the robot and advanced to a side position at the metallizing workstation and the front end of the metallizing applicator emitting a flame to a side portion of the workpiece.

FIG. 17 is an enlarged, fragmentary, isometric, schematic view of a portion of the metallizing system of FIG. 1, illustrating the robot returning the metallizing applicator to the cradle and releasing the metallizing applicator.

FIG. 18 is an enlarged, fragmentary, isometric, schematic view of a portion of the metallizing system of FIG. 1, illustrating the robot acquiring a metallized workpiece from the metallizing workstation and returning it toward a pallet.

FIGS. 19A and 19B constitute a flowchart of a method in accordance with an illustrative embodiment of the present disclosure.

### DETAILED DESCRIPTION

A metallizing system for metallizing mold components used in the manufacture of glass containers and a method for metallizing such components are described below. However, the system and method may be used to metallize other types of components besides mold components, and thus the term “workpiece” is used herein to represent various types of metal components that may be metallized for one reason or another including the mold components mentioned above. In the past, reconditioning of worn mold components involved retooling personnel manually manipulating an oxy-acetylene torch to spray fresh metal onto the mold components at specified workbenches to metallize the components. Such manual metallizing practices, while generally acceptable, often resulted in variances in precision and inconsistent quality from one mold component to another. The metallizing system disclosed herein automates the metallizing process and, as such, reduces the need for manual tasks to be performed when reconditioning worn mold components. By automating the metallizing operation, both process repeatability and the quality of metallized mold components can be improved.

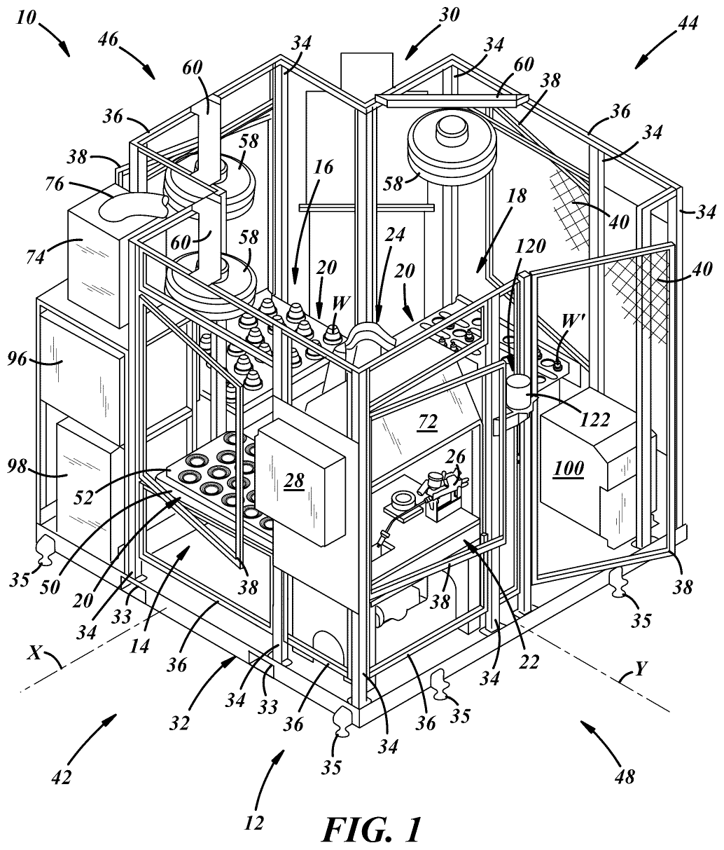

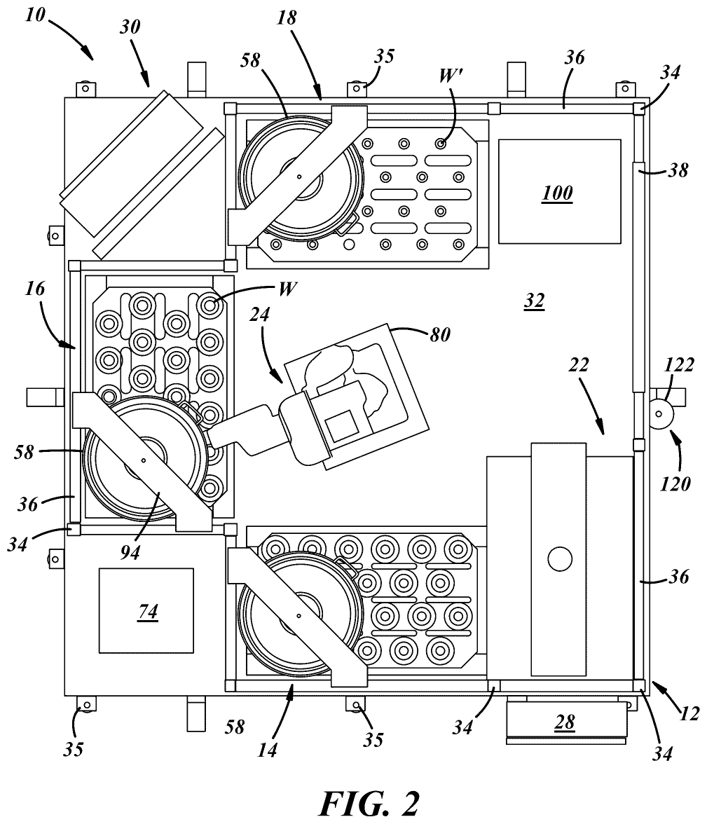

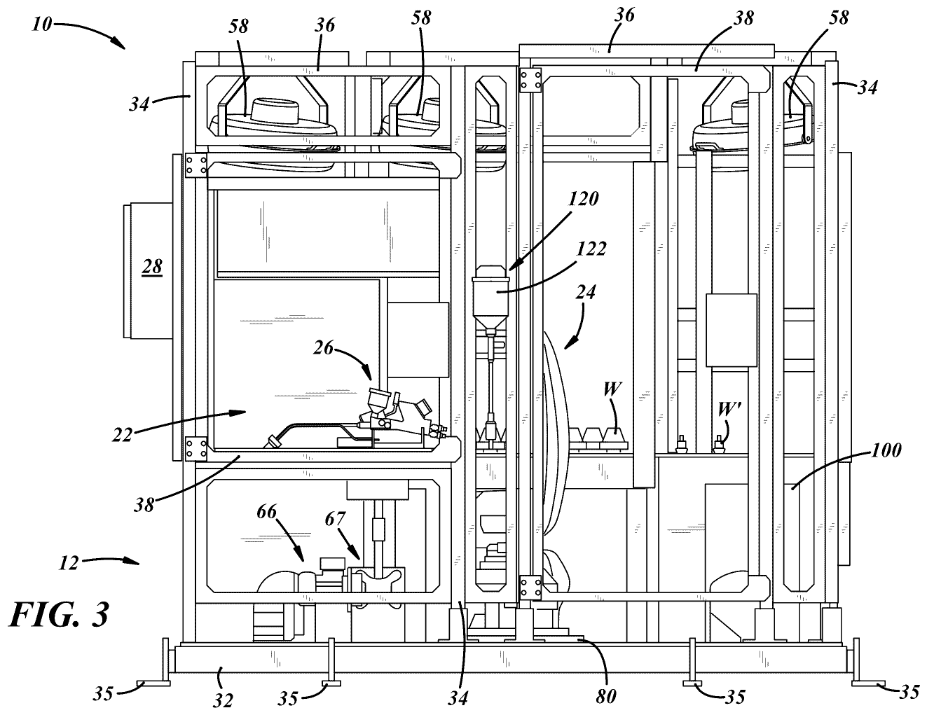

Turning now to FIGS. 1-4, an illustrative embodiment of a metallizing system 10 is shown that includes a system frame 12 to provide support for the rest of the system 10 and to define an operational envelope of the system 10. Within the operational envelope of the system 10, the system 10 includes first, second, and third load/unload stations 14, 16, 18 configured to house pallets 20 that hold worn workpieces W to be processed, such as worn mold components, and that also hold metallized workpieces W′. The metallizing system 10 also includes a metallizing workstation 22 to receive worn workpieces W and to then metallize the worn workpieces W to produce the metallized workpieces W′. The metallizing system 10 further includes an robot 24 to acquire worn workpieces W from one of the load/unload stations 14, 16, 18, move the worn workpieces W to the metallizing workstation 22, and release the worn workpieces W to the metallizing workstation 22. The metallizing system 10 additionally includes a metallizing applicator 26 that is carried at the metallizing workstation 22. The robot 24 is configured to acquire the metallizing applicator 26 and move it towards and away from a worn workpiece W at the metallizing workstation 22, and the metallizing applicator 26 is configured to apply metal material to the worn workpiece W at the metallizing workstation 22 to produce the metallized workpieces W′. The robot 24 is further configured acquire a metallized workpiece W′ from the metallizing workstation 22, move the metallized workpiece W′ to one of the load/unload stations and release the metallized workpiece W′ to one of the pallets 20. The system 10 also includes a user interface 28 and electrical equipment 30 that may be carried by the frame 12 outside the operational envelope of the system 10.

The system frame 12 may include a base 32, vertical supports 34 extending upwardly from the base 32, various cross members 36 supported by the vertical supports 34, and various doors 38 to provide access into the operational envelope of the system 10. The base 32 rests on a factory floor, provides support for the rest of the system frame 12 and other portions of the system 10, and may provide a means for moving the system 10 and a means for anchoring the system 10 to a factory floor. For example, the frame 12 may be palletized in that the base 32 may include lifting tubes or passages 33 to allow the entire frame 12 and most, if not all, of the rest of the system 10 to be moved by a forklift or other suitable transport machine (not shown). In another example, the frame 12 may be anchored by anchors 35 that may be welded, fastened, or otherwise attached to the base 32 and that may be fastened or otherwise attached to a factory floor. The vertical supports 34 together with the cross members 36 and doors 38 may constitute a framework and the supports, cross-members, and doors 34, 36, 38 may be comprised of a rigid material such as steel or aluminum. The system frame 12 may also include outboard barriers 40 extending between the base 32 and cross-members 36 and the vertical supports 34. These barriers 40 may be composed of fencing, metal mesh, polymeric (transparent, translucent, or opaque) panels, or any other suitable material. The system frame 12 may have a front end 42, a rear end 44 opposite the front end 42, and a longitudinal axis X along which the front and rear ends 42, 44 are separated. The system frame 12 also may have a left side 46, a right side 48, and a lateral axis Y along which the left and right sides 46, 48 are separated. The load/unload stations 14, 16, 18 house the pallets 20, and each may include one of the doors 38 and may establish entrances to and exits from the metallizing system 10. The pallets 20 each may include a pallet base 50 and a pallet panel 52 carried on the pallet base 50.

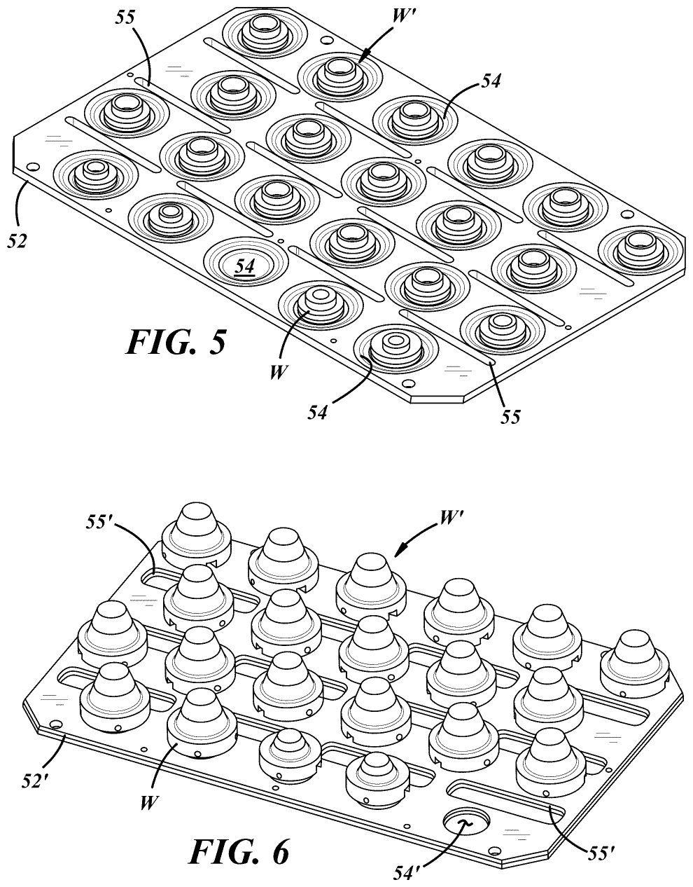

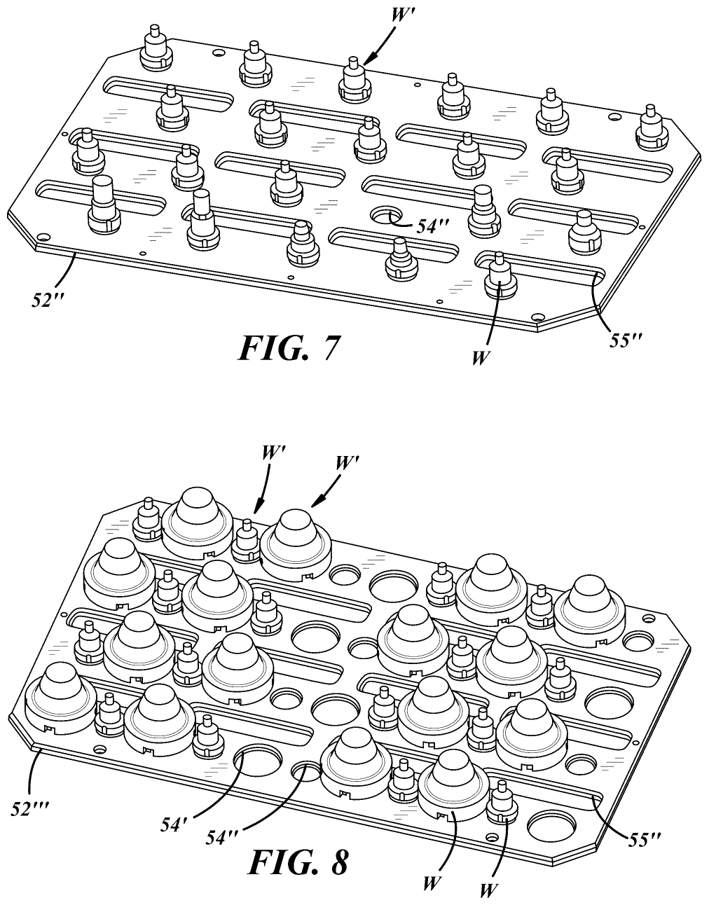

Referring now to FIGS. 5-7, several pallet panels 52, 52′, 52″ establish a plurality of workpiece holders 54, 54′, 54″, for example, pockets, to hold worn and metallized workpieces W, W′, which may be the same or different types of workpieces. The workpiece holders 54, 54′, 54″ also, or instead, may include posts, nubs, or any other retention features to hold workpieces in place. Moreover, as shown here, the plurality of workpiece holders 54, 54′, 54″ may be arranged in a matrix such as, for example, a rectangular matrix, to allow for easy inventory management of the workpieces W, W′. Additionally, the pallet panels 52, 52′, 52″ may include vent passage 55, 55′, 55″ between rows or columns of the workpieces to facilitate cooling thereof. Also, with reference to FIG. 8, a pallet panel 52′″ may have at least two different types of workpiece holders, a first type of workpiece holder 54′ for a first type of workpiece such as a baffle and a second type of workpiece holder 54″ for a second type of workpiece such as a plunger.

Referring again to FIG. 1, the pallet bases 50 may be disposed at a human working level height and may be a structure separate from or integral with the system frame 12. In one particular implementation, the pallet panel 52 may translatable relative to the system frame 12 into and out of the load/unload stations 14, 16, 18 on rails (not shown) or some other lateral conveyance guide such that a pre-loaded pallet may be received at the system 10, or may be fixed to the pallet base 50 or may simply rest on the pallet base 50 for individual workpiece loading and unloading at the system 10. The load/unload stations 14, 16, 18 further may include workpiece coolers 58 configured to cool the metallized workpieces W′ and brackets 60 coupled to the coolers 58 and coupled to the frame 12, for instance, upper crossmembers 36 of the frame 12. The coolers 58 may be fans, refrigeration devices, or any other coolers suitable for cooling hot metallized workpieces W′ as they rest on the pallet panels 52 at the stations 14, 16, 18.

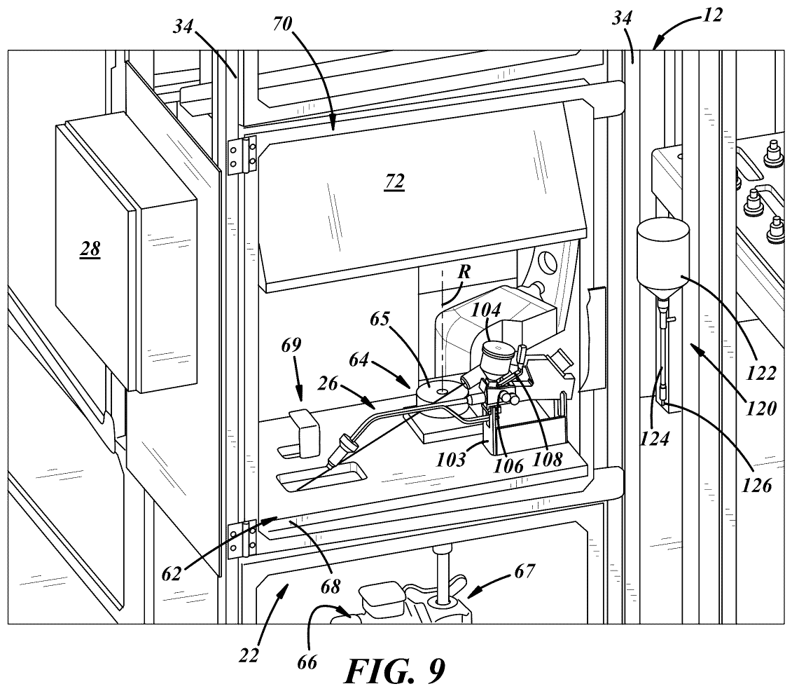

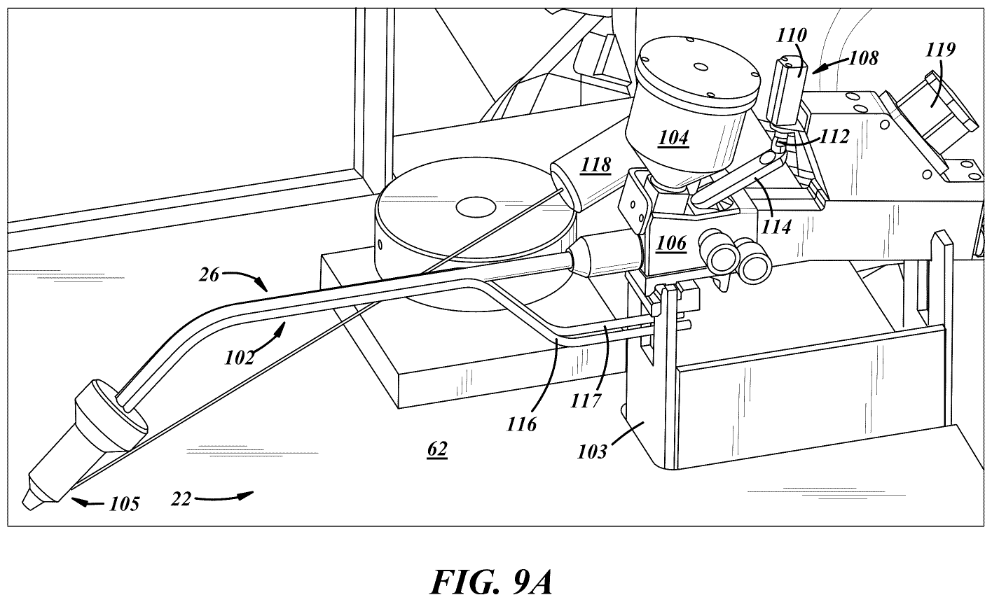

Referring now to FIG. 9, the metallizing workstation 22 is positioned at the right side 48 of the system 10, for instance, in a corner proximate to the user interface 28. The metallizing workstation 22 includes a metallizing worktable 62 having a spindle 64 that may be rotatable about a fixed rotational axis R, for instance, a fixed vertical rotational axis. The metallizing worktable 62 may be fixed, for instance, in a horizontal position. The spindle 64 is carried by the metallizing worktable 62 and includes a chuck 65. The chuck 65 is configured to receive and hold one of the worn workpieces W, preferably by actuatable jaws, and the spindle 64, including the chuck 65, is rotatable about the rotational axis R to rotate the worn workpiece W during metallizing. The metallizing workstation 22 may include a spindle motor 66 and geartrain 67, or any other suitable device(s), to rotate the spindle 64 and the chuck 65. To protect underlying structural materials and components, including, for example, the motor 66 and geartrain 67 that drive rotation of the chuck 65, the metallizing worktable 62 may include one or more refractory plates 68 under the spindle 64 and the chuck 65. The metallizing workstation 22 may also include a spark igniter 69, for instance an electric spark igniter, that may be located proximate a working end of the metallizing applicator 26. Additionally, the metallizing workstation 22 also includes an exhaust system 70 including an exhaust hood 72 that may be carried by the frame 12 above the metallizing worktable 62, an exhaust extractor 74 (FIG. 1) that may be carried by the frame 12 outside the operational envelope of the system 10, and an exhaust conduit 76 (FIG. 1) in fluid communication between the exhaust hood 70 and the exhaust extractor 72.

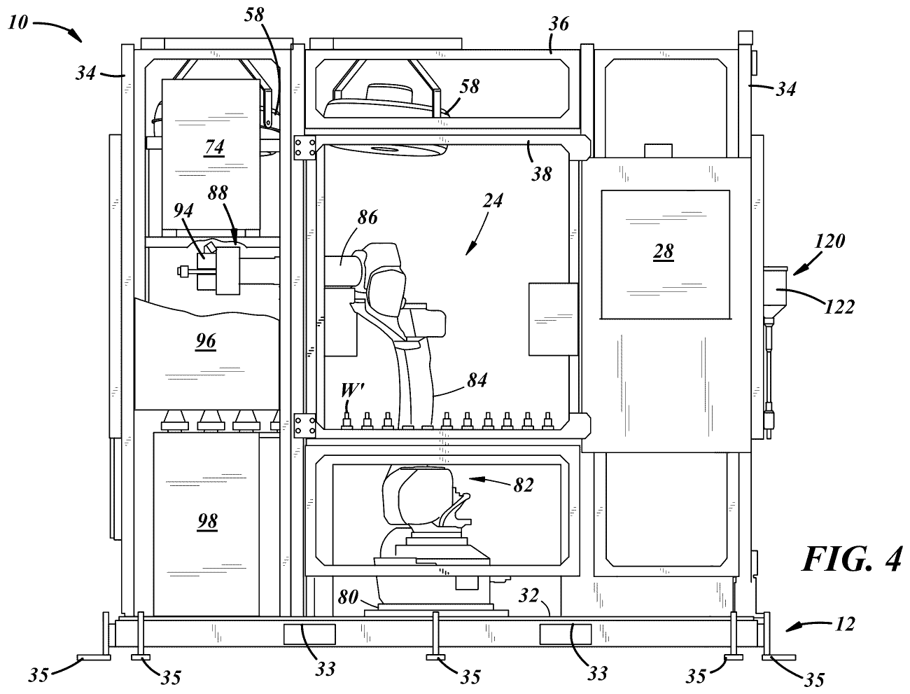

Referring again to FIG. 4, the robot 24 may be an articulating robot, for example, a six-axis robot that may be carried on the base 32 of the system frame 12, for example. The robot 24 may include a robot base 80 coupled to an upper surface of the frame base 32, a shoulder 82 rotatably coupled to the base 80, a lower arm 84 pivotably coupled to the shoulder 82, an upper arm 86 pivotably coupled to the lower arm 84, and a wrist 88 rotatably coupled to the upper arm 86. The robot 24 is configured to rotate about a base swivel axis (S-axis), pivot the lower arm 84 about a lower arm axis, pivot the upper arm 86 about an elbow axis, pivot the wrist 88 about a wrist pitch axis, rotate the wrist 88 about a wrist yaw axis, and pivot the wrist end about a wrist roll axis, to establish six degrees of freedom. In other embodiments, the robot 24 may have any other suitable quantity of axes that allows the robot 24 to articulate. The robot 24 may include various servomotors to facilitate rotating and pivoting the robot 24 about the various axes.

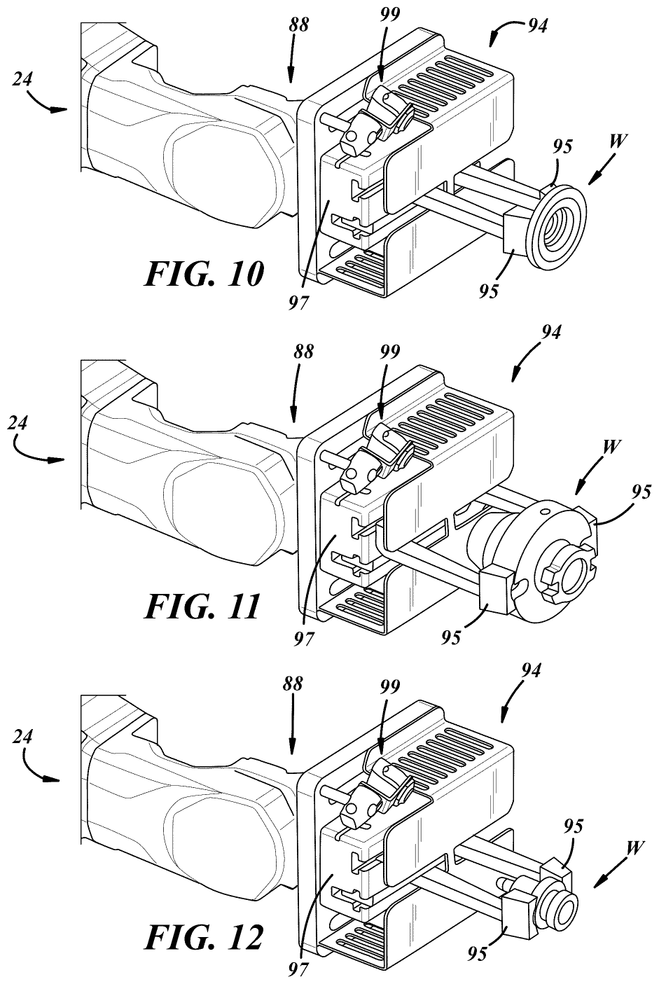

Additionally, as shown in FIGS. 10-12, the robot 24 includes a universal end-effector in the form of a workpiece and metallizing applicator gripper 94 disposed on an end of the wrist 88 that is operable to acquire the worn and metallized workpieces W, W′ and transfer the workpieces W, W′ within the system 10. The gripper 94 may be a common gripper configured to acquire and release not only the metallizing applicator 26 but also at least two different types of workpieces, for example, two or more mold components including, for instance, mold bodies, neck rings, neck ring guide plates, guide rings, plungers, baffles, or bottom plates. The common gripper 94 may include opposed jaws 95 that may be closed and opened by linear actuators 97, for example, pneumatic, hydraulic, or electric linear actuators. The common gripper 94 also may include a workpiece presence sensor 99 that is configured to confirm when the workpiece W, W′ is acquired and released by the common gripper 94. In one example, the system 10 is configured to move the robot 24 to a worn workpiece W with an open common gripper 94, advance the robot 24 further toward the workpiece W so that the open common gripper 94 surrounds the workpiece W, close the common gripper 94 around the workpiece W acquire the workpiece W, and sense whether the workpiece W is present in the closed common gripper 94 via the sensor 99. If the workpiece W is sensed as present, then the robot 24 moves the workpiece W to another portion of the system 10, for example, the chuck 65 of the metallizing workstation 22. Otherwise, the robot 24 may try again to acquire the workpiece W, may try to acquire a different workpiece at a different location, may revert to a home position and await further instruction, or take any other action suitable for the implementation.

With reference again to FIG. 1, the common gripper 94 is able to acquire a worn workpiece W from one of the pallets 20 at one of the load/unload stations 14, 16, 18, transfer the worn workpiece W to the metallizing worktable 62 at the metallizing workstation 22, and release the worn workpiece W onto the chuck 65 of the spindle 64. After the worn workpiece W is metallized into the metallized workpiece W′, the common gripper 94 is able to acquire the metallized workpiece W′ from the chuck 65 of the spindle 64, transfer the metallized workpiece W′ to one of the load/unload stations 14, 16, 18, and release the metallized workpiece W′ onto one of the pallets 20. Although the robot 24 of the illustrated embodiment may be a six-axis articulating robot, any other type of articulating robot may be used that is suitable to handle the workpieces W, W′ including an overhead gantry type of robot with X, Y, and Z orthogonal operational axes. Of course, the robot 24 may be controlled by a robot controller 96 that may be carried outside the operational envelope of the system 10. In some installations where different plant or utility power is used, a dedicated robot power transformer 98 may be desirable to adjust power for the robot 24. Additionally, the system 10 may include a water processor 100 may be carried by the frame 12 and may include a recirculating pump and a chiller (not separately shown) to provide chilled water to the metallizing applicator 26.

Referring now to FIG. 9A, the metallizing applicator 26 may include a flame spray torch 102 and may be carried in a cradle 103 carried by the metallizing worktable 62 of the metallizing workstation 22. The metallizing applicator 26 also may include a hopper 104 that holds a metal material in powder form and is in flow communication with the flame spray torch 102, a flow valve 106 between the hopper 104 and the flame spray torch 102, and a valve actuator 108 to actuate the flow valve 106. The flame spray torch 102 may include an oxy-acetylene Colmonoy torch, or any other torch, operable to heat a worn workpiece being metallized with an emitted flame, receive powdered metal material into the torch flame to create a thermal metallic spray that includes depositable molten metal, and apply the thermal metallic spray onto the worn workpiece W to deposit a metallized layer of metal and, thus, produce a metallized workpiece W′. The term “depositable molten metal” means metal in particulate form that is molten or semi-molten such that the metal particles will blend or fuse together into the metallized layer of metal.

In the illustrated embodiment, the valve actuator 108 includes a pneumatic cylinder 110 and a piston 112 movable with respect to the cylinder 110 to displace a movable flap or lever 114 of the valve 106 so that introduction of the powdered metal material into the torch flame can be controlled. Actuating the movable lever 114 in this particular embodiment opens the valve 106 to allow powdered metal material to flow from the hopper 104 and into the torch 102 for application to the worn workpiece W. In other embodiments, the valve actuator 108 may include an electromechanical device, such as a solenoid or linear actuator, to actuate the flow valve 106. The metallizing applicator 26 also may include coolant inlet and outlet lines 116, 117 in fluid communication between the water processor 100 (FIG. 1) and a cooled nozzle 105 of the torch 102. The metallizing applicator 26 additionally may include a workpiece presence sensor 118 that is configured to confirm when a worn workpiece W is loaded to the chuck 65 of the spindle 64 on the worktable 62. Accordingly, the system 10 is configured to use the sensor 118 to confirm that the workpiece W is present before metallizing begins to avoid wasting metallizing powder on a phantom workpiece. In one example, the sensor 118 may sense presence of the workpiece W a few millimeters above a locating surface of the chuck 65 or worktable 62. The metallizing applicator 26 further may include a gripper boss 119 that may be shaped to correspond to the robot gripper 94 (FIG. 4) to facilitate reliable acquisition, grip, and release of the metallizing applicator 26 by the robot 24 (FIG. 4).

Referring again to FIG. 9, the system 10 also may include an automatic powdered metal handler 120 that may be carried by the frame 12 and may include a fixed hopper 122 to receive metallizing powder that may be poured therein manually by an operator standing outside of the operational envelope of the system 10, a dispensing conduit 124 extending downwardly from the fixed hopper 122 and having a nozzle 126 configured to align with an inlet aperture of a cover of the metal hopper 104 of the metallizing applicator 26 when the robot 24 moves the metallizing applicator 26 under the dispensing conduit 124. The handler 120 also may include a low level sensor (not separately shown) configured to sense when material in the fixed hopper 122 falls below a desired level and send a signal to a system or machine controller (not separately shown) that, in turn, can alert an operator via an alarm, light, screen message, or any other suitable alert to refill the fixed hopper 122. The system 10 may be configured to automatically fill, partially or completely, the hopper 104 every nth metallizing cycle, for example, every 5th metallizing cycle. The handler 120 also may include any suitable valves (not separately shown) that may be actuated by the system 10 and a vibrator (not separately shown) to shake loose powder from the fixed hopper 122 down through the conduit 124 and into the hopper 104 of the metallizing applicator 26.

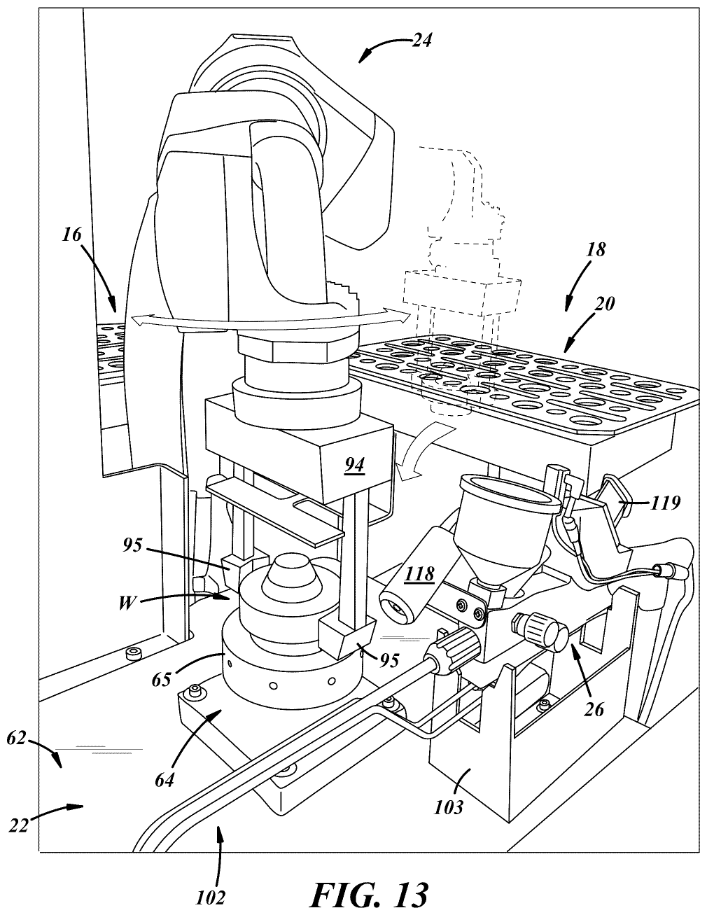

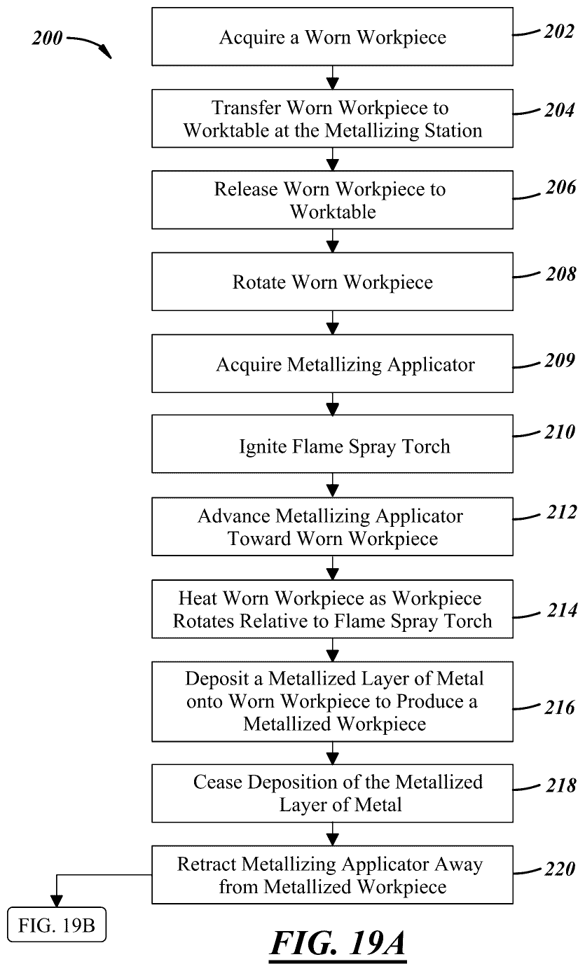

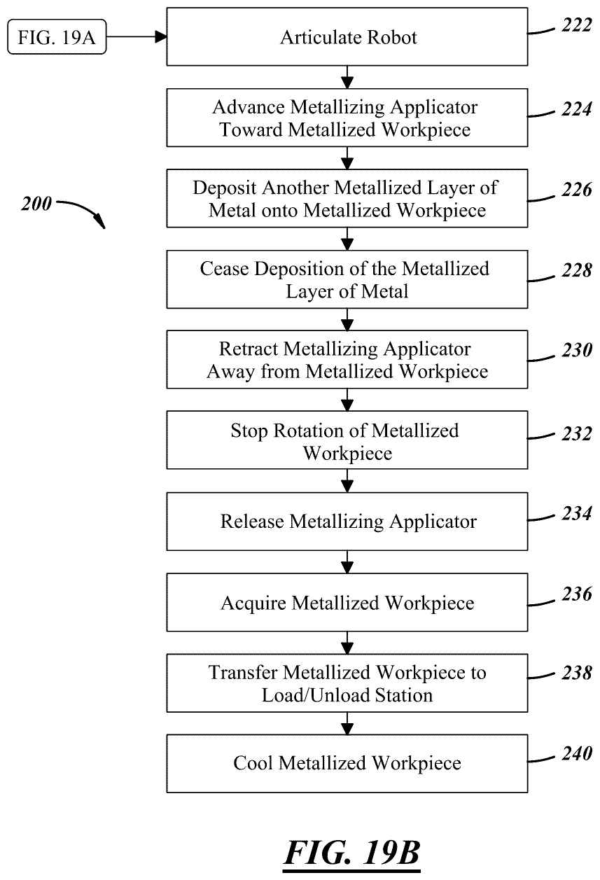

FIGS. 19A and 19B show an illustrative method 200 for metallizing worn workpieces W, such as worn mold components, and is described in the context of using the metallizing system 10 described above and shown in FIGS. 1-12, although the method 200 may be practiced with other metallizing systems not shown or described herein. The metallizing method 200 includes a variety of steps 202-240, some or all of which may be performed sequentially with respect to other steps and/or simultaneously with one or more other steps, and will be described in conjunction with FIGS. 13-18. The metallizing method 200 ultimately involves delivering a worn workpiece W to the metallizing worktable 62 and, more specifically, to the chuck 65 of the spindle 64, and metallizing the worn workpiece W to produce a metallized workpiece W′, with at least the metallizing operation being automated. An “automated” metallizing operation means that the worn workpiece W is moved relative to a flame and that a metallized layer of metal is applied to the worn workpiece W without hand manipulation of either the worn workpiece W or the flame spray torch 102 during such metallization.

With reference to FIGS. 13 and 19A, in a worn workpiece acquiring step 202, one of the worn workpieces W is acquired. In the metallizing system 10, for example, the worn workpiece W is acquired from one of the pallets 20 at one of the load/unload stations 14, 16, 18. This includes activating the robot 24 so that the common gripper 94 grips one of the worn workpieces W, which may involve articulating the robot 24 to bring the common gripper 94 over the pallet 20 and above the worn workpiece W to be metallized and then moving the common gripper 94 downwards so that the common gripper 94 can grip the intended workpiece W. Next, in a worn workpiece transfer step 204, the acquired worn workpiece W is moved to the metallizing workstation 22 where automated metallizing is performed. In the metallizing system 10, the acquired worn workpiece W, which is being held by the common gripper 94, is moved by the robot 24 from the pallet 20 to the metallizing workstation 22 by activating the robot 24 to move one or more portions of the robot 24 to achieve the requisite movement of the workpiece W. Once at the metallizing workstation 22, the common gripper 94 places the worn workpiece W on the chuck 65 of the spindle 64, which is carried by the metallizing worktable 62. Then, in a worn workpiece releasing step 206, the worn workpiece W is released at the metallizing workstation 22. In the metallizing system 10, for instance, the worn workpiece W is released by the common gripper 94 and is received by the chuck 65 of the spindle 64. At this time, the actuatable jaws of the chuck 65 may be engaged to retain the worn workpiece W.

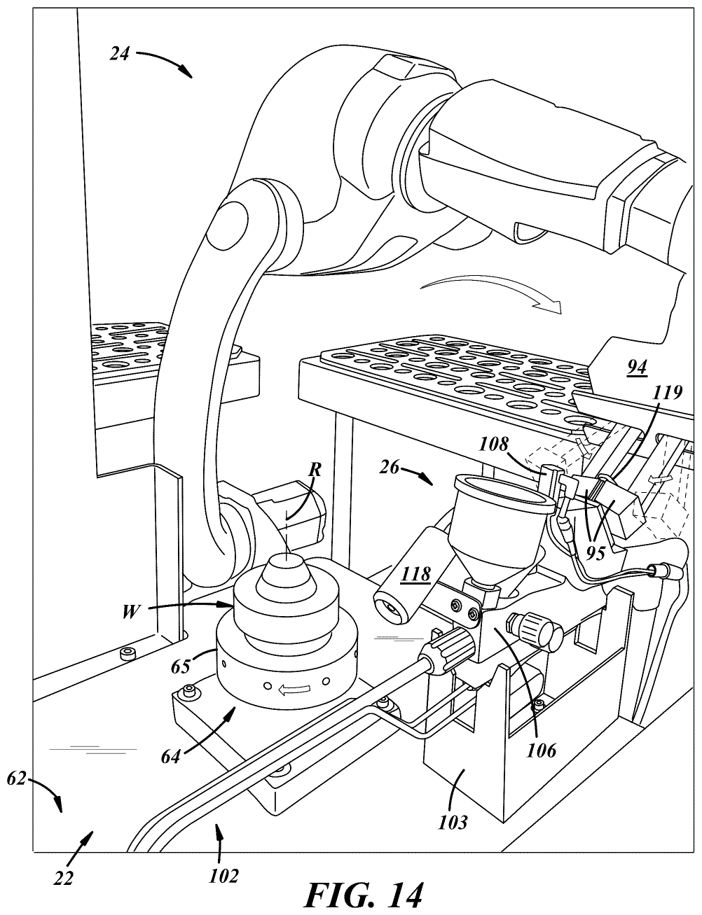

With reference to FIGS. 14 and 19A, in a workpiece rotation step 208, the spindle 64 is rotated to rotate the chuck 65 about the rotation axis R, which, in turn, rotates the worn workpiece W correspondingly. The spindle 64 and the chuck 65 may be rotated by activating the motor and geartrain 66, 67 (FIG. 9) at the metallizing workstation 22. In a metallizing applicator acquisition step 209, the robot 24 acquires the metallizing applicator 26. For example, in the metallizing system 10, the robot 24 moves so that the common gripper 94 is positioned above the common gripper boss 119 of the metallizing applicator 26 that rests in its cradle 103, then the common gripper 94 opens to spread the common gripper jaws 95, thereafter the robot 24 moves downwardly until the common gripper boss 119 is positioned between the opened gripper 94, and then the common gripper 94 closes to collapse the common gripper jaws 95 toward one another to grip the common gripper boss 119.

In an ignition step 210, the flame spray torch 102 is ignited. For example, in the metallizing system 10, the flame spray torch 102 may be ignited by activating the robot 24 to move the flame spray torch 102 of the metallizing applicator 26 to the spark igniter 69 (FIG. 9), supplying an ignitable gas that includes oxygen and fuel (e.g., acetylene), for example, through the torch 102, and activating the igniter 69. Moving the flame spray torch 102 to the igniter 69 (FIG. 9) is carried out by moving one or more portions of the robot 24 as needed to bring the torch 102 into proximity with the igniter 69.

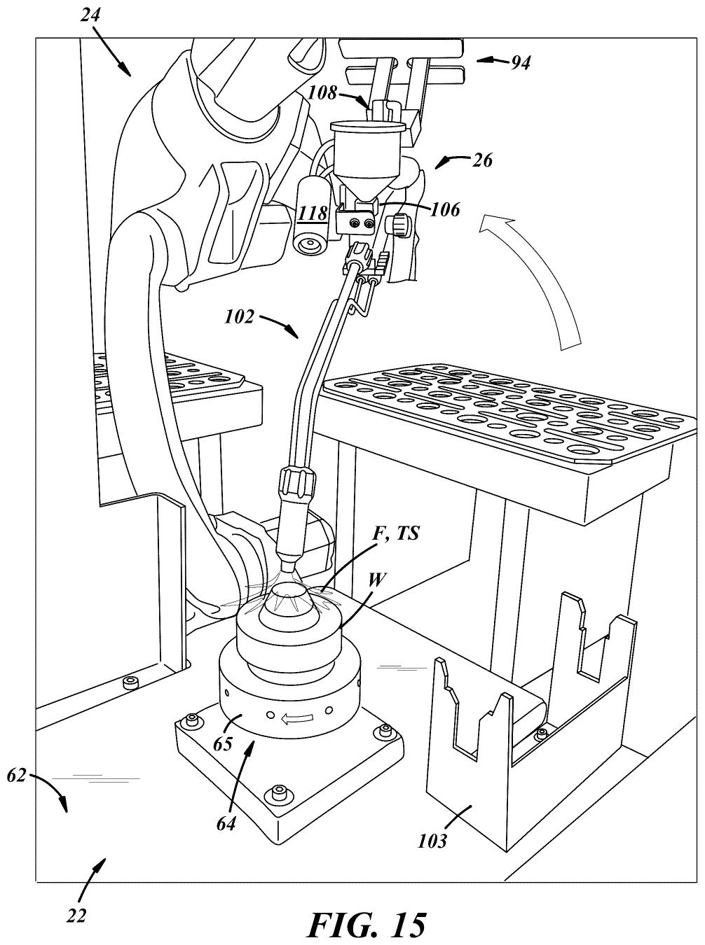

With reference to FIGS. 15 and 19A, in a metallizing applicator advancing step 212, the metallizing applicator 26, with the ignited flame spray torch 102, is advanced toward the worn workpiece W to the advanced position. In the metallizing system 10, the metallizing applicator 26 is advanced toward the worn workpiece W, which is retained in the chuck 65 of the spindle 64 on the metallizing worktable 62, by activating the robot 24 to move one or more portions of the robot 24 to effectuate movement of the metallizing applicator 26 into proximity of the worn workpiece W. In a workpiece heating step 214, the worn workpiece W is heated while the worn workpiece W is rotated relative to the flame spray torch 102 and, more particularly, relative to and through the emitted flame F of the flame spray torch 102. For example, in the metallizing system 10, this heating step 214 may include impinging the flame F from the flame spray torch 102 onto the worn workpiece W as the motor 66 and geartrain 67 rotate the spindle 64 and the chuck 65 and, thus, the retained worn workpiece W within the flame F. Such heating of the worn workpiece W with the flame F rapidly increases the temperature of the selected and localized surfaces of the worn workpiece W that are affected by the flame F to a temperature conducive to fused adhesion of the powdered metal material. Unlike heating in an oven, the heating step 214 described here quickly heats the selected surfaces of the worn workpiece W that are intended to receive the metallized layer without having to expend needless energy heating the entire worn workpiece W. The flame intensity, fuel gas used, flame impingement time, and other heating parameters may be adjusted to achieve the desired workpiece surface temperature.

With continued reference to FIGS. 15 and 19A, the method 200 also includes a metal application step 216 in which a metallized layer of metal is deposited onto the worn workpiece W to produce the metallized workpiece W′. In the metallizing system 10, for example, this step 216 may involve activating the valve actuator 108 of the metallizing applicator 26 to actuate the flow valve 106 by displacing the movable lever 114 (FIG. 14), which in turn introduces the powdered metal material into the flame F being emitted from the flame spray torch 102 to create the thermal metallic spray TS. As the worn workpiece W is rotated relative to the flame from the torch 102 and through the thermal metallic spray TS, the metal contained within the thermal metallic spray TS contacts and fuses to the worn workpiece W, thus resulting in the deposition of the metallized layer of metal to the worn workpiece W to produce the metallized workpiece W′. The metallizing time of this step 216 may vary depending on the amount of metallized metal desired to be applied. Additionally, the flame intensity, fuel gas used, flame impingement time, and other heating parameters may be adjusted to achieve desired metal application qualities.

After at least a portion of the metallized layer is deposited, a metal application cessation step 218 is performed that involves ceasing deposition of the metallized layer of metal to the now metallized workpiece W′. For example, in the metallizing system 10, this step 218 may include deactivating the valve actuator 108 such that the movable lever 114 of the flow valve 106 returns to its initial position under spring pressure, for example, to stop flow of powdered metal material from the hopper 104 to the flame spray torch 102.

Next, in a metallizing applicator retracting step 220, the metallizing applicator 26 is retracted away from the metallized workpiece W′ to the retracted position. For example, in the metallizing system 10, the metallizing applicator 26 is retracted away from the metallized workpiece W′, which is still retained in the chuck 65 of the spindle 64 on the metallizing worktable 62, by activating the robot 24 to move one or more portions of the robot 24. The emitted flame F of the flame spray torch 102 may also-but does not have to-be extinguished by stopping the flow of the ignitable gas through the torch 102 after the metal application cessation step 218 or the metallizing applicator retracting step 220. At this point, the metallized workpiece W′ may include a sufficient metallized layer of metal that the workpiece W′ may be acquired by the common gripper 94 the common gripper 94, transferred to one of the pallets 20 of one of the stations 18, or additional metal may be applied to the metallized workpiece W′ in one or more additional rounds of metallizing.

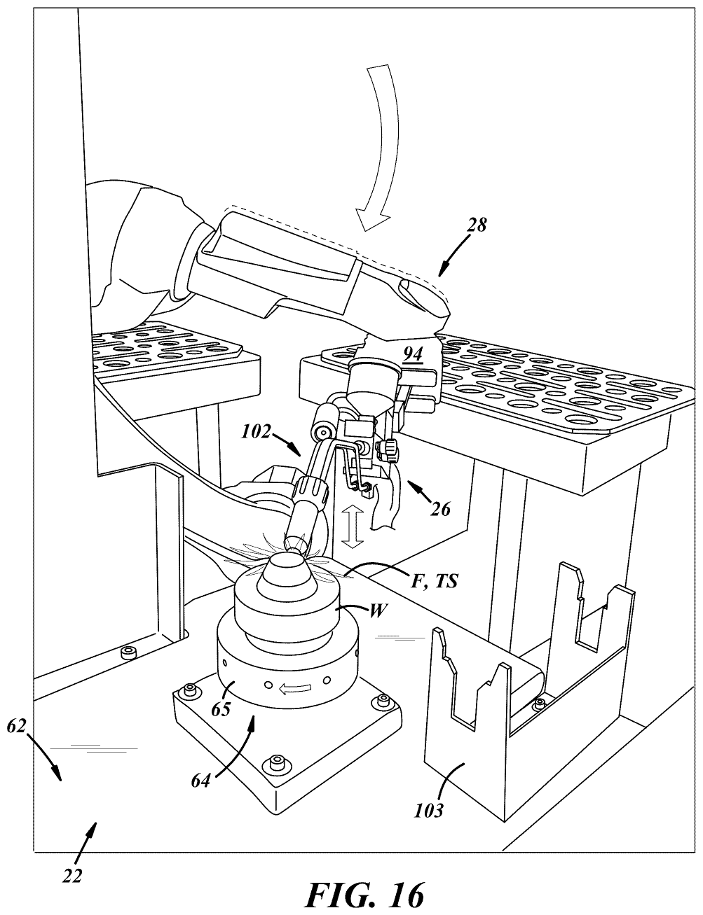

With reference to FIGS. 16 and 19B, if additional metallizing is desired, the robot 24 may be moved to a different position in a robot articulating step 222, for example, to change the distance and/or angle at which the flame F impinges the metalized workpiece W′ and the powdered metal material is applied as a metallized layer of metal during the next round of metallizing. In the metallizing system 10, the robot articulating step 222, if practiced, may include moving one or more portions of the robot 24 to move the metallizing applicator 26 in the intended angular direction. Regardless of whether the robot articulating step 222 is practiced, another metallizing applicator advancing step 224 is performed to again advance the metallizing applicator 26 toward the metallized workpiece W′ to the advanced position. And, depending on whether or not the flame F from the flame spray torch 102 was previously extinguished, the ignition step in which the flame spray torch 102 is ignited may be performed as described above prior to the metallizing applicator advancing step 224, although when multiple rounds of metallizing are being practiced the flame F preferably is not extinguished between the previous metal application step 216 and the subsequent metal application step.

Another metal application step 226 may be performed in which in which another metallized layer of metal is deposited onto the metallized workpiece W′, either over a different portion of the workpiece W′ or over the previously deposited metallized layer of metal, as the workpiece W′ is rotated relative to the flame spray torch 102 and through the thermal metallic spray TS. Another workpiece heating step may also be performed prior to the metal application step 226 if the metallized workpiece W′ lost too much heat after the previous metal application step 216.

After at least some of the metallized layer is deposited, another metal application cessation step 228 is performed, which involves ceasing deposition of the metallized layer of metal to the metallized workpiece W′, followed by another metallizing applicator retracting step 230 in which the metallizing applicator 26 is retracted away from the metallized workpiece W′ to the retracted position. The metallizing applicator advancing step 224, the metal application step 226, the metal application cessation step 228, and the metallizing applicator retracting step 230, mentioned here in connection with the additional round of metallizing may be carried out in the same matter as the corresponding steps 212, 216, 218, 220, 222 described above.

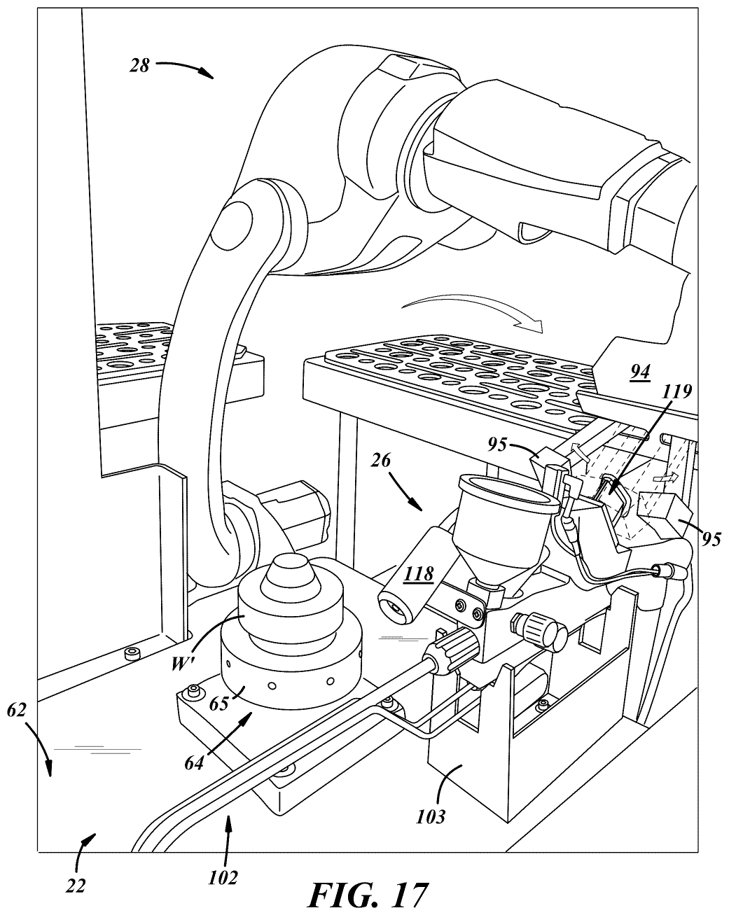

With reference to FIGS. 17 and 19B, after the initial metal application cessation step 218 and preferably after the initial metallizing applicator retracting step 220, if no additional metallizing is practiced, or otherwise after the additional metal application step 228 and preferably after the additional metallizing applicator retracting step 230, the rotation of the metallized workpiece W′ is stopped in a workpiece rotation cessation step 232 by stopping the rotation of the spindle 64 and the chuck 65. The metallizing applicator 26 is then released by the robot 24 in a metallizing applicator releasing step 234, wherein the robot 24 releases the metallizing applicator 26. For example, in the metallizing system 10, the robot 24 moves toward the cradle 103 until the metallizing applicator 26 is positioned in or just above the cradle 103, then the common gripper 94 opens to spread the common gripper jaws 95 and release the metallizing applicator 26 and, thereafter, the robot 24 moves upwardly and away from the metallizing applicator 26.

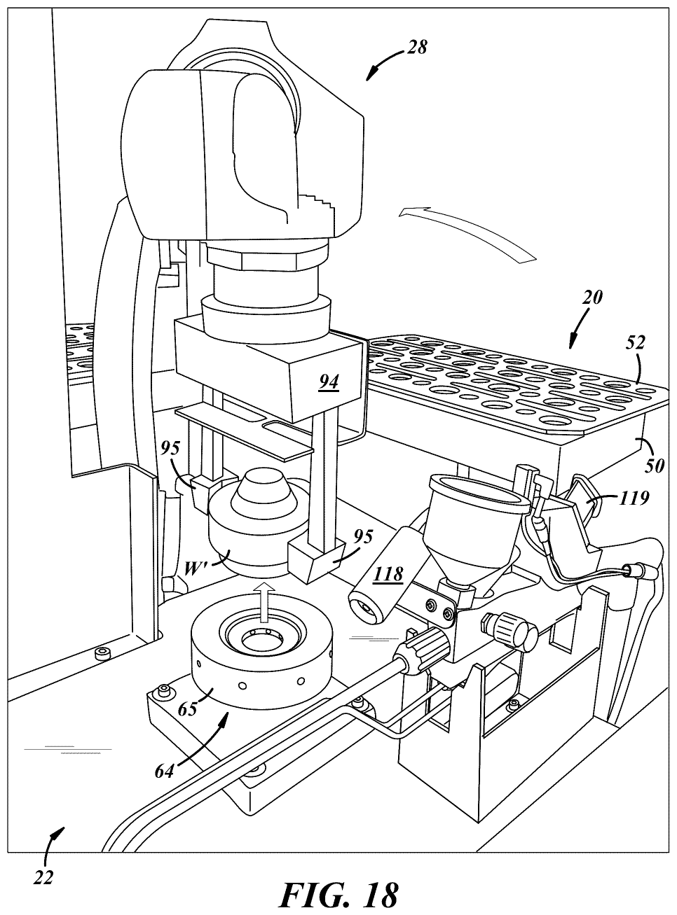

With reference to FIGS. 18 and 19B, the metallized workpiece W′ is thereafter acquired in a metallizing workpiece acquiring step 236. In the metallizing system 10, this step 236 includes activating the robot 24 so that the common gripper 94 moves toward the metallized workpiece W′ and grips the metallized workpiece W′. Gripping the metallized workpiece W′ with the common gripper 94 involves moving one or more portions of the robot 24 to bring the common gripper 94 to the metallizing workstation 22 and over the metallized workpiece W′ and then moving the common gripper 94 downwards so that the common gripper 94 can grip the metallized workpiece W′ that is still retained in the chuck 65. Once the common gripper 94 has engaged and gripped the metallized workpiece W′, the actuatable jaws of the chuck 65 are disengaged from the workpiece W′ and the common gripper 94 is moved upwardly to remove the metallized workpiece W′ from the chuck 65 of the spindle 64 at the metallizing workstation 22. The metallized workpiece W′ is next transferred from the metallizing workstation 22 to the one of the pallets 20 of one of the load/unload stations 14, 16, 18 in a metallized workpiece transfer step 238. For instance, in the metallizing system 10, the acquired metallized workpiece W′, which is being held by the common gripper 94, is moved by the robot 24 from the metallizing workstation 22 to the pallet 20 by activating the robot 24 to achieve the requisite movement of the metallized workpiece W′. The metallized workpiece W′ is then released by the common gripper 94 onto the pallet 20.

In a metallized workpiece cooling step 240, the metallized workpiece W′ is cooled at its respective load/unload station 14, 16, 18 by one of the respective coolers 58 of the metallizing system 10 as shown in FIG. 1. The coolers 58 may be configured to operate for a desired time, for instance, thirty minutes, after the last metallized workpiece W′ is placed on its respective pallet 20. Once cooled, the metallized workpiece W′ may be retrieved and removed from the metallizing system 10 in any suitable manner.

The method 200 also may include a step of moving, with the robot 24, the metallizing applicator 26 to the automatic powdered metal handler 120, and a step of dispensing powdered metal from the automatic powdered metal handler 120 into the hopper 104 of the metallizing applicator 26.

With reference again to FIGS. 1 and 9, the user interface 28 may be part of a system or machine controller that may be used to carry out various aspects of the presently disclosed apparatus and method. The controller may receive input data and instructions from a user via the user interface 28 and/or signals from other portions of the system 10 including workpiece presence sensors 99, 118, automatic powdered metal hopper level sensor(s), and any other suitable sensor(s), process the received input in light of stored software and/or data, and transmit output signals to other portions of the system 10 including the robot 24, the coolers 58, the spindle motor 66, the exhaust system 70, the water processor 100, and/or the valve and/or vibrator of the powdered metal handler 120. Conversely, the controller may receive input signals from various portions of the system 10, processes the received input signals in light of stored data and software, and transmit output data to the user via the user interface 28. The controller may include, for example, memory, a processor coupled to the memory, one or more interfaces coupled to the processor, one or more input devices coupled to the processor, and/or one or more output devices coupled to the processor, and may be powered by utility power, plant power, battery power, and/or in any other suitable manner.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, or feature, and should not be construed as rendering indefinite any disclosure herein. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. The present disclosure is intended to embrace all embodiments and modifications of the subject matter of this application that fall within the scope of the accompanying claims.

1. A metallizing system comprising:
a metallizing worktable configured to receive and rotate a worn workpiece;
a metallizing applicator being movable towards and away from the metallizing worktable and including a flame spray torch configured to deposit a metallized layer of metal onto the worn workpiece as the worn workpiece rotates relative to the flame spray torch; and
a robot configured to acquire and release the worn workpiece and to acquire and release the metallizing applicator, and configured to move the worn workpiece and to move the metallizing applicator.

2. The metallizing system set forth in claim 1, wherein the metallizing worktable includes a spindle rotatable about a fixed rotational axis and the robot articulates the metallizing applicator relative to the fixed rotational axis.

3. The metallizing system set forth in claim 1, wherein the robot has a gripper used to grip the worn workpiece and the metallizing applicator.

4. The metallizing system set forth in claim 1, wherein the metallizing applicator includes further includes a hopper that holds a powdered metal material and is in flow communication with the flame spray torch, a flow valve between the hopper and the flame spray torch, and a valve actuator to actuate the flow valve.

5. The metallizing system set forth in claim 1, further comprising a spark igniter located on the metallizing worktable.

6. The metallizing system set forth in claim 1, further comprising:
a load/unload station; and
a pallet at the load/unload station,
wherein the robot is configured to acquire the worn workpiece from the pallet, move the worn workpiece to the metallizing worktable, and release the worn workpiece to the metallizing worktable.

7. The metallizing system set forth in claim 1, wherein the robot includes a six-axis articulating robot with a gripper configured to acquire the worn workpiece and release the worn workpiece to the metallizing worktable.

8. The metallizing system set forth in claim 1, further comprising:
a pallet configured to hold the worn workpiece; and
a cradle to hold the metallizing applicator when the robot is handling the worn workpiece.

9. A metallizing system for metallizing worn workpieces into metallized workpieces, the metallizing system comprising:
a load/unload station;
a pallet at the load/unload station and including a plurality of workpiece holders;
a metallizing worktable having a spindle that is rotatable about a rotation axis and includes a chuck;
a metallizing applicator carried by a cradle on the metallizing worktable and being movable towards and away from the spindle and including a flame spray torch configured to emit a flame and receive powdered metal material into the flame to create a thermal metallic spray; and
a robot including a common gripper configured to acquire a worn workpiece from the pallet, transfer the worn workpiece to the metallizing worktable, and release the worn workpiece to the chuck of the spindle, and also configured to acquire the metallizing applicator from the cradle, articulate the metallizing applicator into position to metallize the worn workpiece into a metallized workpiece, return and release the metallizing applicator to the cradle, acquire the metallized workpiece from the chuck of the spindle, transfer the metallized workpiece to the pallet, and release the metallized workpiece onto the pallet.

10. The metallizing system set forth in claim 9, wherein the load/unload station includes a cooler operable to cool the metallized workpiece on the pallet.

11. The metallizing system set forth in claim 9, wherein the rotational axis of the spindle is a fixed rotational axis and the robot articulates the metallizing applicator relative to the fixed rotational axis.

12. The metallizing system set forth in claim 9, wherein the robot includes a six-axis articulating robot.

13. The metallizing system set forth in claim 9, wherein the metallizing applicator further includes a hopper that holds a powdered metal material and is in flow communication with the flame spray torch, a flow valve between the hopper and the flame spray torch, and a valve actuator to actuate the flow valve.

14. The metallizing system set forth in claim 9, further comprising:
a base that supports the robot and the metallizing worktable; and
a frame carried by the base around the robot and the metallizing worktable.

15. A method of metallizing a worn workpiece to produce a metallized workpiece, the method comprising:
delivering a worn workpiece to a spindle carried on a metallizing worktable using a robot, the spindle having a chuck and wherein the worn workpiece is received in the chuck;
advancing, using the robot, a metallizing applicator towards the metallizing worktable and the worn workpiece, the metallizing applicator including a flame spray torch that emits a flame;
rotating the spindle to rotate the worn workpiece relative to the flame spray torch such that the worn workpiece rotates through the flame to heat the worn workpiece;
depositing a metallized layer of metal onto the worn workpiece to produce a metallized workpiece by introducing a powdered metal material into the flame of the flame spray torch to create a thermal metallic spray while continuing to rotate the spindle such that the worn workpiece is rotated relative to the flame spray torch and through the thermal metallic spray; and
retracting the metallizing applicator away from the metallized workpiece and the metallizing worktable.

16. The method set forth in claim 15, wherein the step of delivering the worn workpiece to the metallizing worktable comprises:
acquiring the worn workpiece with a gripper of the robot;
transferring the worn workpiece to the metallizing worktable with the gripper of the robot; and
releasing the worn workpiece from the gripper to the metallizing worktable.

17. The method set forth in claim 16, wherein the step of acquiring the worn workpiece comprises acquiring, with the gripper of the robot, the worn workpiece from a pallet that includes a plurality of worn workpieces.

18. The method set forth in claim 16, further comprising:
acquiring the metallizing applicator with the gripper of the robot, after the transferring step; and
releasing the metallizing applicator from the gripper of the robot, after the retracting step.

19. The method set forth in claim 18, further comprising:
transferring, with the robot, the metallized workpiece from the metallizing worktable to a pallet, after the releasing step.

20. The method set forth in claim 16, further comprising:
moving, with the robot, the metallizing applicator to an automatic powdered metal handler; and
dispensing powdered metal from the automatic powdered metal handler into a hopper of the metallizing applicator.
